(19) United States
(12) Patent Application Publication
(10) Pub. No.: US 2025/0342803 A1
(43) Pub. Date: Nov. 6, 2025

(54) ELECTROLUMINESCENCE DISPLAYER AND DRIVER CIRCUIT AND PIXEL CIRCUIT AND CONTROL METHOD THEREOF

(71) Applicant: ULTRADISPLAY INC., Hsinchu (TW)

(72) Inventors: Dsun-Chie Twu, Hsinchu (TW); Ching-Chung Kan, Hsinchu (TW); Chun-Chieh Liu, Taipei (TW)

(21) Appl. No.: 18/744,747

(22) Filed: Jun. 17, 2024

(30) Foreign Application Priority Data
May 2, 2024 (TW) 113116351

(51) Int. Cl. G09G 3/3233; G09G 3/20

(52) U.S. Cl. CPC G09G 3/3233; G09G 3/2007; G09G 2300/0819; G09G 2300/0842; G09G 2310/08; G09G 2320/0223; G09G 2320/0233

(57) ABSTRACT

An electroluminescence displayer includes a light emitting device array, plural pixel circuits, and a driver circuit. The light emitting device array includes plural light emitting devices, arranged in plural rows and plural columns. Each pixel circuit is respectively coupled to at least one corresponding light emitting device, to supply at least one corresponding display current to the at least one corresponding light emitting device according to at least one display signal. The driver circuit is coupled to the plural pixel circuits, to provide a luminance current to the plural pixel circuit correspondingly according to a digital luminance signal. Wherein the electroluminescence displayer controls the corresponding pixel circuit in a current control manner to convert the luminance current to the at least one display current that flows through the at least one corresponding light emitting device.

### CROSS REFERENCE

The present invention claims priority to TW 113116351 filed on May 2, 2024.

### BACKGROUND OF THE INVENTION

### Field of Invention

The present invention relates to an electroluminescence displayer, and a driver circuit, a pixel circuit, and a control method thereof. More particularly, it refers to such electroluminescence displayer, driver circuit, pixel circuit, and control method thereof, wherein the electroluminescence displayer controls the corresponding pixel circuit in a current control manner, to convert a luminance current to a display current that flows through at least one corresponding light emitting device.

### Description of Related Art

FIG. 1 shows a schematic diagram of a prior art pixel 140 in the US patent application US20080048949A1. As shown in FIG. 1, a pixel 140 includes an organic light-emitting diode (OLED) and a pixel circuit 142. In the case of a pixel 140 in the n-th row and the m-th column, the pixel circuit 142 of the n-th row and the m-th column is connected to the m-th data line Dm, the n-th scan line Sn, and the n-th emission control line En, and controls the corresponding OLED.

An anode electrode of the OLED is connected to the pixel circuit 142, while its cathode electrode is connected to a second power source ELVSS. The OLED generates light with a predetermined luminance corresponding to a current supplied to it by the pixel circuit 142.

When a corresponding scan signal is supplied to the scan line Sn, the pixel circuit 142 controls the amount of current supplied to the OLED based on the corresponding data signal supplied to the data line Dm. More specifically, a predetermined current from a driving transistor included in the pixel circuit 142 is supplied to the OLED, and a predetermined voltage is applied to the corresponding OLED. In this case, the pixel circuit 142 controls the amount of current flowing to the OLED based on the predetermined voltage applied to the OLED.

As shown in FIG. 1, the pixel circuit 142 includes a first transistor M1, a second transistor M2, a third transistor M3, and a storage capacitor Cst. The gate of the first transistor M1 is connected to the n-th scan line Sn, and the first electrode of the first transistor M1 is connected to the data line Dm. The second electrode of the first transistor M1, i.e., the driving transistor, is connected to the gate of the second transistor M2. When the corresponding scan signal is supplied to the scan line Sn, the first transistor M1 transmits the corresponding data signal supplied to the data line Dm to the gate of the second transistor M2.

The first electrode of the second transistor M2 is connected to the first power source ELVDD. The second electrode of the second transistor M2 is connected to the first electrode of the third transistor M3. The second transistor M2 controls the current flowing from the first power source ELVDD to the second power source ELVSS and through the OLED based on the gate voltage applied to the second transistor M2. The first power source ELVDD, for example, is an internal supply voltage that provides a positive power source, and the second power source ELVSS, for example, is a ground potential.

The first electrode of the third transistor M3 is connected to the second electrode of the second transistor M2, and the second electrode of the third transistor M3 is connected to the OLED. The gate of the third transistor M3 is connected to the emission control line En. When an emission control signal is provided to the emission control line En, for example, when the emission control line is in a high-level state, the third transistor M3 is turned OFF; otherwise, for example, when the emission control line is in a low-level state, the third transistor M3 is turned ON.

One end of the storage capacitor Cst is connected to the gate of the second transistor M2, and the other end is connected to the second electrode of the third transistor M3, i.e., the anode electrode of the OLED. When the first transistor M1 is turned ON, the storage capacitor Cst is charged to a voltage corresponding to the data signal. Furthermore, the storage capacitor Cst transfers a voltage change amount corresponding to the voltage difference at the anode electrode of the OLED to the gate of the second transistor M2.

In the prior art shown in FIG. 1, during the stage where the scan signal Sn is at a high voltage and the emission control signal Dm is at a low voltage, the first transistor M1 is turned OFF, and the third transistor M3 is turned ON. At this stage, the second transistor M2 transmits the current corresponding to the voltage applied to a first node N1 to the OLED. In this case, the voltage at a second node N2 varies according to the following equation:

ΔN2=V_OLED−V_OLED(Vth)

where V_OLED represents the voltage applied to the OLED corresponding to the current flowing through the OLED. Therefore, the voltage V_OLED corresponds to the amount of current flowing through the OLED.

Therefore, the voltage at the first node N1, being in a floating state, will vary according to the voltage change at the second node N2 based on the storage capacitor Cst. In the prior art shown in FIG. 1, since the voltage change at the second node N2 is based on the threshold voltage variation of the second transistor M2, i.e., based on the current flowing to the OLED, the threshold voltage of the second transistor M2 is compensated based on the voltage change at the second node N2. Thus, in the prior art shown in FIG. 1, the second transistor M2 subsequently transmits the current corresponding to the voltage applied to the first node N1 to the OLED, causing the OLED to generate light with a predetermined luminance corresponding to the current supplied to it.

In the prior art shown in FIG. 1, the brightness control method of the OLED is a voltage control method determined by the voltage of the data line Dm. By changing the voltage applied to the first node N1, the brightness of the OLED is changed and determined correspondingly.

The prior art shown in FIG. 1 has at least the following disadvantages: First, an overall area of the displayer including the pixel circuit 142 is relatively large, making miniaturization difficult; second, the transistors in the plural pixel circuits 142 do not match each other, and the current flowing through each transistor at the same gate-source voltage is different, causing the luminance of the display image to be uneven across different areas. If this luminance unevenness needs to be corrected, the circuit becomes more complex, and the time required to display the image is longer.

Specifically, the prior art displayer requires a larger area unit gain buffer or voltage follower to provide the voltage to control the brightness of the OLED. Additionally, as previously mentioned, a compensation circuit design is needed to correct for transistor mismatches, contributing to a larger overall circuit area of the displayer.

Furthermore, it is noted that since the pixel 140 is controlled by voltage and driven by voltage, the first transistor M1, the second transistor M2, and the third transistor M3 all function as switches, operating in ON/OFF mode to control the brightness of the OLED with the gate-source voltage of the second transistor M2. In summary, this is a source driver control method well known to those skilled in the art and will not be elaborated here. In this voltage control mode, as previously mentioned, the circuit is relatively complex, and the overall circuit area is larger.

In view of the above, the present invention proposes an electroluminescence displayer, and a driver circuit, a pixel circuit, and a control method thereof with a simpler circuit design, smaller overall area, and the ability to precisely control the luminance of the light-emitting devices.

### SUMMARY OF THE INVENTION

In one perspective, the present invention provides an electroluminescence displayer, comprising: a light emitting device array, which includes a plurality of light emitting devices arranged in a plurality of rows and a plurality of columns; a plurality of pixel circuits, wherein each pixel circuit is respectively coupled to at least one corresponding light emitting device, to supply at least one corresponding display current to the at least one corresponding light emitting device according to at least one display signal; and a driver circuit, coupled to the plural pixel circuits, to provide a first luminance current to the corresponding pixel circuit according to a digital luminance signal; wherein the electroluminescence displayer controls the corresponding pixel circuit in a current control manner, to convert the first luminance current to the display current that flows through the at least one corresponding light emitting device.

In another perspective, the present invention provides a driver circuit of an electroluminescence displayer, wherein the electroluminescence displayer includes a light emitting device array, which includes a plurality of light emitting devices arranged in a plurality of rows and a plurality of columns; a plurality of pixel circuits, wherein each pixel circuit is respectively coupled to at least one corresponding light emitting device, to supply at least one corresponding display current to the at least one corresponding light emitting device according to at least one display signal; and the driver circuit coupled to the plural pixel circuits to provide a first luminance current to the corresponding pixel circuit according to a digital luminance signal; wherein the electroluminescence displayer controls the corresponding pixel circuit in a current control manner to convert the first luminance current to the display current that flows through the at least one corresponding light emitting device; the driver circuit of the electroluminescence displayer, comprising: a reference current source, which is configured to operably provide a reference current; and a plurality of current DACs, wherein each current DAC is configured to operably convert the reference current to a first luminance current according to the digital luminance signal, wherein the first luminance current is positively correlated with the reference current.

In another perspective, the present invention provides a pixel circuit of an electroluminescence displayer, wherein the electroluminescence displayer includes a light emitting device array, which includes a plurality of light emitting devices arranged in a plurality of rows and a plurality of columns; a plurality of pixel circuits, wherein each pixel circuit is respectively coupled to at least one corresponding light emitting device, to supply at least one corresponding display current to each corresponding light emitting device according to at least one display signal; and a driver circuit coupled to the plural pixel circuits to provide a first luminance current to the corresponding pixel circuit according to a digital luminance signal; wherein the electroluminescence displayer controls the corresponding pixel circuit in a current control manner to convert the first luminance current to the display current that flows through the at least one corresponding light emitting device; the pixel circuit of the electroluminescence displayer, comprising: a transimpedance circuit, which is configured to operably convert the first luminance current to a holding voltage; a transconductance circuit, which is configured to operably convert the holding voltage to a second luminance current, wherein the second luminance current is positively correlated with the first luminance current; and at least one display switch, which is configured to operably convert the second luminance current to the corresponding display current according to the display signal, to supply the corresponding display current to the corresponding light emitting device.

In one embodiment, the display signal includes a pulse width modulation (PWM) signal with a duty ratio, and the PWM signal is used to switch the corresponding display switch, thereby generating the display current to determine a grayscale of the corresponding light emitting device.

In one embodiment, the pixel circuit further includes at least one bypass current path, wherein each bypass current path and the corresponding display switch are commonly coupled to a current outflow node of the transconductance circuit to bypass the corresponding display current when the corresponding display switch is turned OFF.

In one embodiment, the pixel circuit further includes a capacitor, which is coupled to the transimpedance circuit during a refresh period to maintain the holding voltage and coupled to the transconductance circuit during a display period to provide the holding voltage to the transconductance circuit.

In one embodiment, the capacitor includes a gate capacitor of a MOS capacitor.

In one embodiment, the pixel circuit further includes a refresh switch to couple the driver circuit to the capacitor during the refresh period according to a refresh signal to charge/discharge the capacitor to maintain the holding voltage.

In one embodiment, the pixel circuit further includes an auxiliary switch to electrically couple a transimpedance current outflowing node to a transimpedance control node of the transimpedance transistor of the transimpedance circuit during the refresh period, configured as a diode-connected transistor to couple the capacitor in parallel between a first power source and the current DAC to charge/discharge the capacitor to maintain the holding voltage.

In one embodiment, the auxiliary switch is turned OFF after the refresh period, and the capacitor is coupled to a transconductance inflow node and a transconductance control node of a transconductance transistor of the transconductance circuit during the display period to generate the second luminance current according to the holding voltage, wherein the transimpedance transistor and the transconductance transistor share the same transistor, and the refresh period and the display period do not overlap; wherein the pixel circuit supplies the display current to the at least one corresponding light emitting device during the display period.

In one embodiment, the transimpedance transistor, the auxiliary switch, and a transconductance transistor of the transconductance circuit form a current mirror circuit to mirror the first luminance current to the second luminance current during the refresh period.

In one embodiment, the refresh period and the display period optionally have an overlap period or do not overlap.

In one embodiment, during the refresh period, the electroluminescence displayer synchronously charges the plural gate capacitors corresponding to the plural light emitting devices in at least one row.

In another perspective, the present invention provides a control method for an electroluminescence displayer, comprising: providing a reference current; converting the reference current to provide a first luminance current according to a digital luminance signal, wherein the first luminance current is positively correlated with the reference current; converting the first luminance current to a holding voltage with a transimpedance circuit; converting the holding voltage to a second luminance current with a transconductance circuit, wherein the second luminance current is positively correlated with the first luminance current; and converting the second luminance current to at least one display current according to a display signal to supply the at least one display current to at least one corresponding light emitting device; wherein the first luminance current is converted to the display current that flows through the at least one corresponding light emitting device in a current control manner.

In one embodiment, the control method further comprises: a refresh step, including charging/discharging a capacitor during a refresh period according to a refresh signal to maintain the holding voltage; and providing the holding voltage to the transconductance circuit during a display period.

In one embodiment, the refresh step includes providing an auxiliary switch to electrically couple a transimpedance current outflowing node to a transimpedance control node of the transimpedance transistor of the transimpedance circuit during the refresh period, configured as a diode-connected transistor to couple the capacitor in parallel between a first power source and the current DAC to charge/discharge the capacitor to maintain the holding voltage.

In one embodiment, the control method further comprises: a refresh step, including charging/discharging a capacitor during a refresh period according to a refresh signal to maintain the holding voltage; and providing the holding voltage to the transconductance circuit during a display period.

In one embodiment, the refresh step includes providing an auxiliary switch to electrically couple a transimpedance current outflowing node to a transimpedance control node of the transimpedance transistor of the transimpedance circuit during the refresh period, configured as a diode-connected transistor to couple the capacitor in parallel between a first power source and the current DAC to charge/discharge the capacitor to maintain the holding voltage.

In one embodiment, the electroluminescence displayer operates in a non-overlap mode, and the control method further comprises: turning OFF the auxiliary switch after the refresh period; coupling the capacitor to a transconductance inflow node and a transconductance control node of a transconductance transistor of the transconductance circuit during the display period to generate the second luminance current according to the holding voltage; sharing the same transistor between the transimpedance transistor and the transconductance transistor; and ensuring the refresh period and the display period do not overlap; wherein the pixel circuit supplies the display current to the corresponding light emitting device during the display period.

In one embodiment, the electroluminescence displayer operates in an overlap mode, the refresh step further comprising forming a current mirror circuit with the transimpedance transistor, the auxiliary switch, and the transconductance transistor of the transconductance circuit to mirror the first luminance current to the second luminance current during the refresh period.

In one embodiment, the refresh step of charging/discharging the capacitor during the refresh period to maintain the holding voltage further includes synchronously charging the plural gate capacitors corresponding to the plural light emitting devices in at least one row during the refresh period.

The advantages of the present invention are that the circuit design is simpler, the overall area is smaller, and it can precisely control the brightness of the light-emitting devices.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a prior art pixel 140.

FIG. 2 is a schematic diagram of an electroluminescence displayer according to an embodiment of the present invention.

FIG. 3 is a schematic diagram of the driver circuit of an electroluminescence displayer according to an embodiment of the present invention.

FIG. 4 is a schematic diagram of the pixel circuit of an electroluminescence displayer according to an embodiment of the present invention.

FIG. 5 is a schematic diagram of the pixel circuit of an electroluminescence displayer according to another embodiment of the present invention.

FIG. 6 is a schematic diagram of the signal waveform of the display signal according to an embodiment of the present invention.

FIG. 7 is a schematic diagram of the pixel circuit of an electroluminescence displayer according to an embodiment of the present invention.

FIG. 8A is a schematic diagram of the pixel circuit of an electroluminescence displayer according to yet another embodiment of the present invention.

FIG. 8B is a schematic diagram of the pixel circuit of an electroluminescence displayer according to yet another embodiment of the present invention.

FIG. 9A is a schematic diagram of the pixel circuit of an electroluminescence displayer according to yet another embodiment of the present invention.

FIG. 9B is a schematic diagram of the pixel circuit of an electroluminescence displayer according to yet another embodiment of the present invention.

FIG. 10 is a schematic diagram of the signal waveform of an electroluminescence displayer operating in non-overlap mode according to an embodiment of the present invention.

FIG. 11 is a schematic diagram of the signal waveform of an electroluminescence displayer operating in overlap mode according to yet another embodiment of the present invention.

FIG. 12 is a flowchart of the control method of an electroluminescence displayer according to an embodiment of the present invention.

FIG. 13 is a flowchart of the refresh and display steps in the control method of an electroluminescence displayer according to an embodiment of the present invention.

FIG. 14 is a flowchart of the control method of an electroluminescence displayer operating in non-overlap mode according to an embodiment of the present invention.

FIG. 15 is a flowchart of the control method of an electroluminescence displayer operating in overlap mode, wherein the refresh step further includes a step of forming a current mirror circuit, according to an embodiment of the present invention.

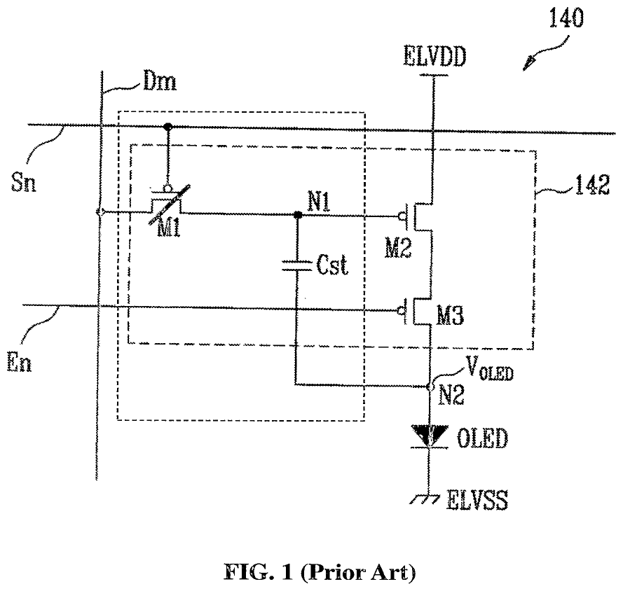

### DESCRIPTION OF THE PREFERRED EMBODIMENTS

The drawings as referred to throughout the description of the present invention are for illustration only, to show the interrelations between the circuits and the signal waveforms, but not drawn according to actual scale.

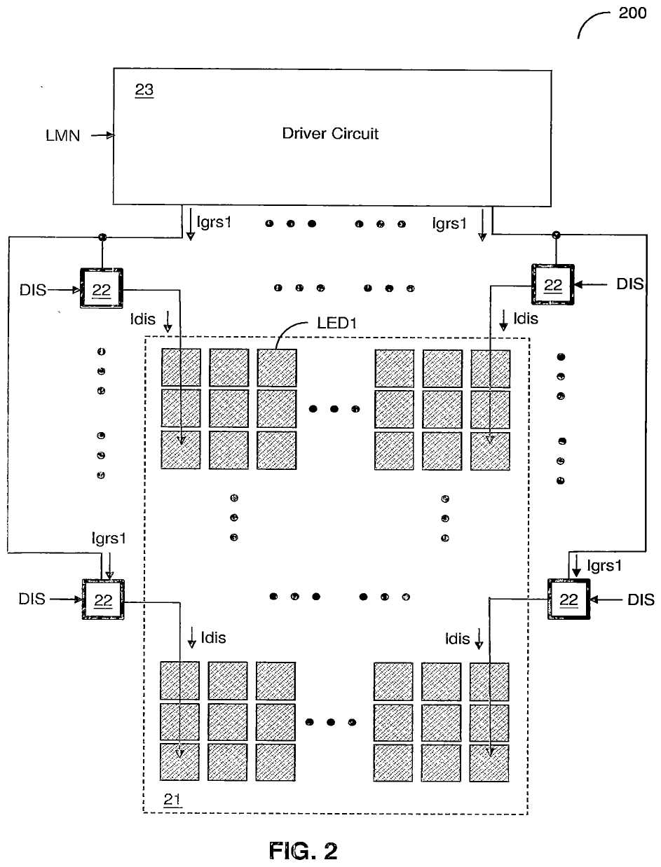

FIG. 2 shows an electroluminescence displayer 200 according to an embodiment of the present invention. The electroluminescence displayer 200 includes a light emitting device array 21, plural pixel circuits 22, and a driver circuit 23. As shown in FIG. 2, the light emitting device array 21 includes plural light emitting devices LED1, which are arranged in plural rows and plural columns. The light emitting devices LED1 can be, but are not limited to, light emitting diodes, micro light emitting diodes, or organic light emitting diodes. Each pixel circuit 22 is respectively coupled to at least one corresponding light emitting device LED1, and the pixel circuit 22 controls the supply of at least one display current Idis to the corresponding light emitting device LED1 according to at least one display signal DIS, thereby controlling the grayscale of the corresponding light emitting device LED1. In one embodiment, one pixel circuit 22 can be coupled to 1 to 3 light emitting devices, for example but not limited to. The driver circuit 23 is coupled to the plural pixel circuits 22 to provide a first luminance current Igrs1 to the corresponding pixel circuit 22 according to a digital luminance signal LMN.

Unlike the prior art which determines the grayscale of the light emitting device by a voltage control manner, the present invention controls the grayscale of the light emitting device by a current control manner. The present invention can further cooperate with a display signal having pulse width modulation to determine the ON-time of the display switch, thereby determining the grayscale of each light emitting device. The driver circuit of the prior art provides an adjusted voltage to the pixel circuit, whereas the driver circuit of the present invention provides an adjusted current (such as the first luminance current Igrs1 in this embodiment) to the pixel circuit. The electroluminescence displayer 200 controls the corresponding pixel circuit 22 in a current control manner to convert the first luminance current Igrs1 to the display current Idis that flows through the corresponding light emitting device LED1. The driver circuit 23 provides the first luminance current Igrs1 instead of voltage, and the corresponding pixel circuit 22 provides the display current Idis according to the first luminance current Igrs1. In this way, compared to the prior art, the present invention can simplify the circuit, reduce the overall area, and precisely control the brightness of the light emitting devices. Furthermore, when the first power source ELVDD or the second power source ELVSS experiences a voltage drop or unstable voltage level, the brightness of the light emitting device in the prior art voltage control manner will be affected, whereas the current control manner of the present invention is less affected. Therefore, the present invention does not require calibration, unlike the prior art which does.

FIG. 3 shows a schematic diagram of the driver circuit of an electroluminescence displayer according to an embodiment of the present invention. As shown in FIG. 3, the driver circuit 23 includes a reference current source 231 and plural current digital-to-analog converters (DACs) 232. The reference current source 231 provides a reference current Is. Each current DAC 232 converts the reference current Is to a first luminance current Igrs1 according to the digital luminance signal LMN, wherein the first luminance current Igrs1 is positively correlated with the reference current Is.

In one embodiment, each current DAC 232 may include a current mirror circuit to mirror and amplify the reference current Is to the first luminance current Igrs1 according to the digital luminance signal LMN. The digital luminance signal LMN is a digital signal that determines the amplification ratio and resolution of the current DAC 232. In one embodiment, the digital luminance signal LMN is used to adjust the overall average luminance of the light emitting device array 21 under different ambient brightness conditions.

In one embodiment, each current DAC 232 provides the first luminance current Igrs1 to each pixel circuit 22 in at least one column. In another embodiment, each current DAC 232 provides the first luminance current Igrs1 to each pixel circuit 22 in a single column. In another embodiment, two or three current DACs 232 provide the first luminance current Igrs1 to each pixel circuit 22 in a single column. The current DAC 232 can be a programmable circuit, capable of driving a single column or plural columns. The implementation of the current DAC 232 is well known to those skilled in the art and will not be elaborated here. In one embodiment, a single reference current source 231 supplies the reference current Is to plural current DACs 232.

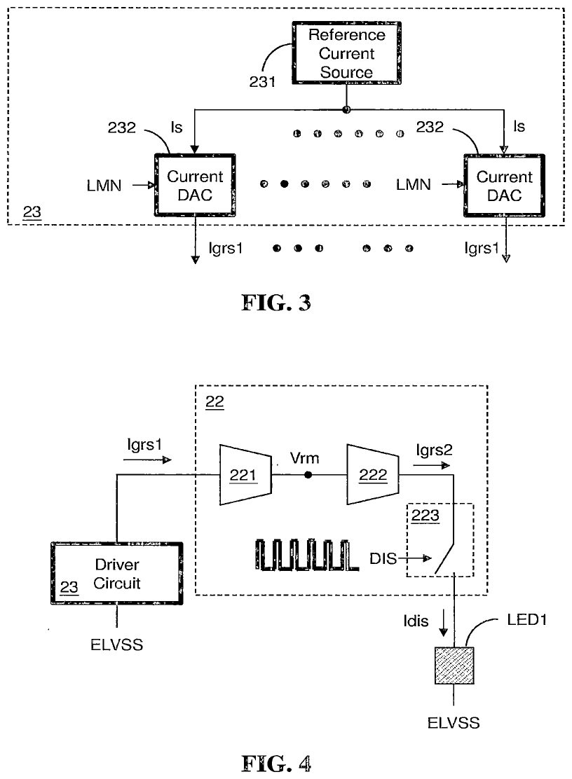

FIG. 4 shows a schematic diagram of the pixel circuit of an electroluminescence displayer according to an embodiment of the present invention. As shown in FIG. 4, the pixel circuit 22 includes a transimpedance circuit 221, a transconductance circuit 222, and a display switch 223. The transimpedance circuit 221 converts the first luminance current Igrs1 to a holding voltage Vrm. The transconductance circuit 222 converts the holding voltage Vrm to a second luminance current Igrs2, wherein the second luminance current Igrs2 is positively correlated with the first luminance current Igrs1. The display switch 223 operates according to the corresponding display signal DIS to convert the second luminance current Igrs2 to the corresponding display current Idis, to supply the corresponding display current Idis to the corresponding light emitting device LED1.

In one embodiment, the second luminance current Igrs2 is proportional to the first luminance current Igrs1; in another embodiment, the second luminance current Igrs2 may be equal to the first luminance current Igrs1. According to the present invention, the first luminance current Igrs1 provided by the driver circuit is converted by the transimpedance circuit 221 and the transconductance circuit 222 to generate the second luminance current Igrs2 that is positively correlated with the first luminance current Igrs1. Compared to the voltage control manner of the prior art, the current control manner of the present invention can reduce the overall circuit area and precisely control the luminance and resolution of the light emitting devices LED1.

In this embodiment, the display signal DIS includes a pulse width modulation (PWM) signal, as schematically shown in the signal waveform inset in FIG. 4, which has a duty ratio. The PWM signal is used to switch the corresponding display switch 223, converting the second luminance current Igrs2 to the display current Idis, thereby determining the grayscale of the corresponding light emitting device LED1.

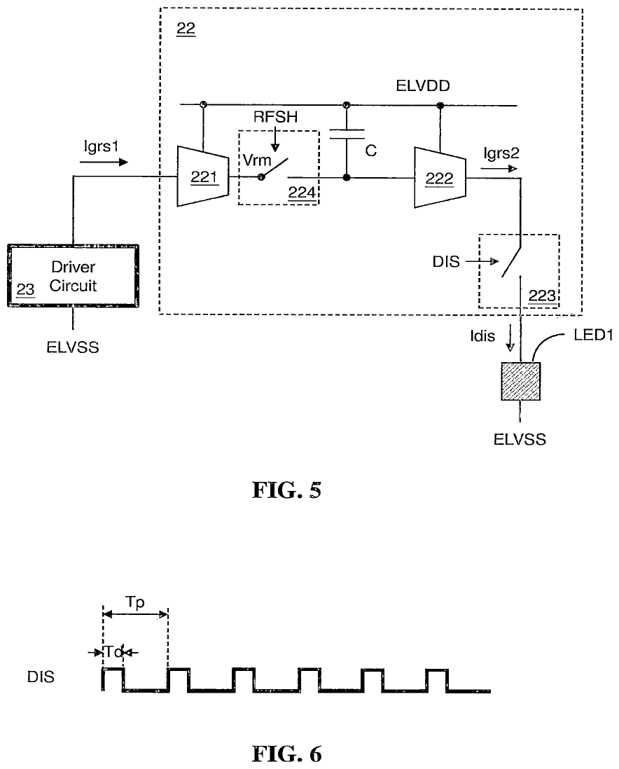

FIG. 5 shows a schematic diagram of the pixel circuit of an electroluminescence displayer according to another embodiment of the present invention. As shown in FIG. 5, compared to the pixel circuit shown in FIG. 4, the pixel circuit 22 in FIG. 5 further includes a capacitor C and a refresh switch 224 in addition to the transimpedance circuit 221, the transconductance circuit 222, and the display switch 223. The capacitor C is coupled to the transimpedance circuit 221 during a refresh period to maintain the holding voltage Vrm, and is coupled to the transconductance circuit 222 during a display period to provide the holding voltage Vrm to the transconductance circuit 222. As shown in FIG. 5, the refresh switch 224 couples the driver circuit 23 to the capacitor C during a refresh period according to a refresh signal RFSH. One end of the capacitor C is coupled to the first power source ELVDD, and the other end is coupled between the transimpedance circuit 221 and the transconductance circuit 222. In one embodiment, during the refresh period, the driver circuit 23 is coupled to the capacitor C to charge/discharge the capacitor C, thereby maintaining the holding voltage Vrm. In one embodiment, after the refresh switch 224 is turned OFF, the transconductance circuit 222 can generate the second luminance current Igrs2 according to the holding voltage Vrm maintained by the capacitor C.

FIG. 6 shows a schematic diagram of the signal waveform of the display signal according to an embodiment of the present invention. As shown in FIG. 6, the display signal DIS, for example, is a PWM signal with a duty ratio. The PWM signal is used to operate the display switch 223, converting the second luminance current Igrs2 to the display current Idis, thereby determining the grayscale of at least one corresponding light emitting device LED1. For example, the higher the duty ratio of the display signal DIS, the higher the grayscale of at least one corresponding light emitting device LED1. As shown in FIG. 6, the duty ratio is the ratio of the ON-time Td to the period Tp, i.e., the duty ratio equals the ON-time Td divided by the period Tp.

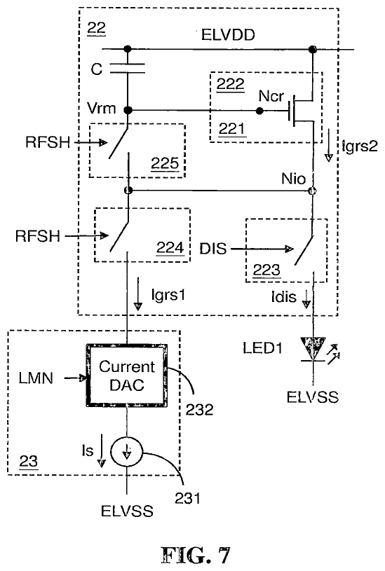

FIG. 7 shows a schematic diagram of the pixel circuit of an electroluminescence displayer according to an embodiment of the present invention. This embodiment illustrates a schematic diagram of a pixel circuit 22 that can operate in a non-overlap mode. As shown in FIG. 7, the pixel circuit 22 includes a transimpedance circuit 221, a transconductance circuit 222, a display switch 223, a refresh switch 224, an auxiliary switch 225, and a capacitor C. In this embodiment, the transimpedance circuit 221 and the transconductance circuit 222 share the same transistor, as shown in FIG. 7. During the refresh period, the refresh switch 224 and the auxiliary switch 225 operate according to a refresh signal RFSH to electrically connect a transimpedance current outflowing node Nio of the transimpedance transistor of the transimpedance circuit 221 to a transimpedance control node Ncr, configuring the transimpedance transistor as a diode-connected transistor. The transimpedance diode-connected transistor and the capacitor C are coupled in parallel between the first power source ELVDD and the current digital-to-analog converter 232 of the corresponding driver circuit 23, charging/discharging the capacitor C to maintain the holding voltage Vrm. The configuration of the transistor as a diode-connected transistor and the gate capacitance of the MOS capacitor are well known to those skilled in the art and will not be elaborated here.

Continuing with FIG. 7, the refresh switch 224 operates according to the refresh signal RFSH. In this embodiment, the refresh switch 224 and the auxiliary switch 225 operate synchronously to charge/discharge the capacitor C during the refresh period. The refresh switch 224 and the auxiliary switch 225 turn OFF after the refresh period to prevent leakage of the capacitor C.

In the pixel circuit 22 shown in FIG. 7, it operates in a non-overlap mode, meaning that the refresh period and the display period do not overlap. Therefore, the transimpedance circuit 221 and the transconductance circuit 222 can share the same transistor. During the refresh period, the shared transistor serves as the transimpedance transistor of the transimpedance circuit 221; during the display period, the shared transistor serves as the transconductance transistor of the transconductance circuit 222. In one embodiment, the refresh signal RFSH is a periodic signal with a fixed period, charging the capacitors C of plural pixel circuits 22 in the light-emitting device array 21 in turn during the refresh period. In one embodiment, the period of the refresh signal RFSH is related to the leakage rate of the capacitor C. It should be noted that the non-overlapping of the refresh period and the display period refers to the same pixel circuit 22; that is, while one pixel circuit 22 operates in the display period, another pixel circuit 22 can operate in the refresh period.

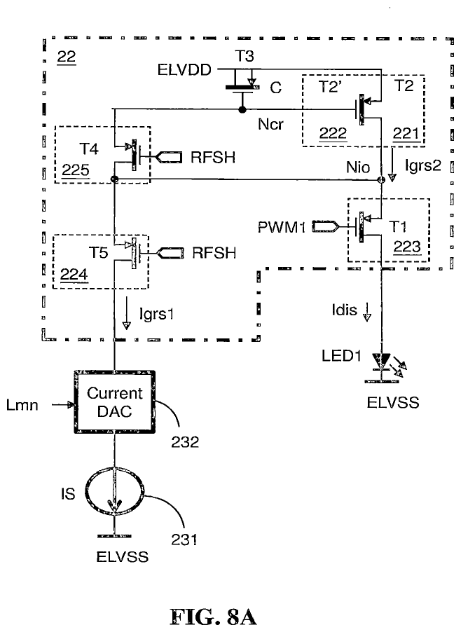

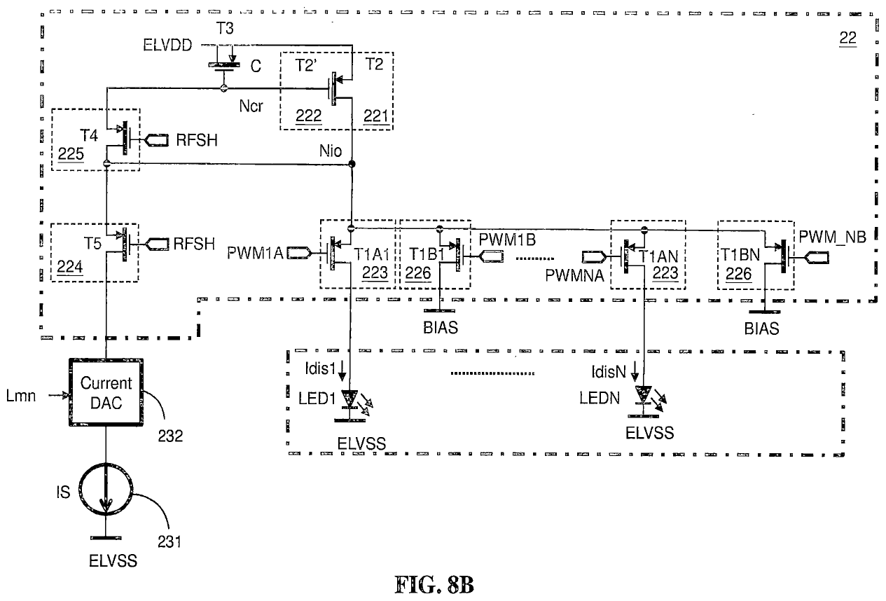

FIG. 8A shows a schematic diagram of the pixel circuit of an electroluminescence displayer according to yet another embodiment of the present invention. The pixel circuit 22 shown in FIG. 8A is a more specific embodiment of the pixel circuit 22 shown in FIG. 7. As shown in FIG. 8A, in the pixel circuit 22, the display switch 223 includes a display transistor T1, the transimpedance circuit 221 includes a transimpedance transistor T2, the transconductance circuit 222 includes a transconductance transistor T2′, the capacitor C includes the gate capacitance T3 of a MOS capacitor, the auxiliary switch 225 includes an auxiliary transistor T4, and the refresh switch 224 includes a refresh transistor T5. In this embodiment, the transimpedance transistor T2 and the transconductance transistor T2′ are the same transistor. The display transistor T1 operates according to the PWM signal PWM1, which serves as the display signal DIS. In this embodiment, the display transistor T1, the transimpedance transistor T2, the gate capacitance T3, the transconductance transistor T2′, the auxiliary transistor T4, and the refresh transistor T5 are all P-type metal-oxide-semiconductor (MOS) devices. According to the present invention, the display transistor T1, the transimpedance transistor T2, the gate capacitance T3, the transconductance transistor T2′, the auxiliary transistor T4, and the refresh transistor T5 can also be NMOS devices, with corresponding adjustments to the connections and circuits.

In this embodiment, the drain of the transimpedance transistor T2 of the transimpedance circuit 221 serves as the transimpedance current outflowing node Nio, and the gate serves as a transimpedance control node Ncr. In this embodiment, the gate capacitance T3 serves as the capacitor C. In one embodiment, during the refresh period, the electroluminescence displayer 200 synchronously charges the gate capacitances T3 of the pixel circuits corresponding to plural light-emitting devices LED1 in at least one row.

Continuing with FIG. 8A, during the refresh period, the refresh signal RFSH turns ON the auxiliary transistor T4 and the refresh transistor T5, causing the first luminance current Igrs1 to flow through the transimpedance transistor T2 and the gate capacitance T3, which are coupled between the first power source ELVDD and the current DAC 232. That is, the sum of the currents flowing through the transimpedance transistor T2 and the gate capacitance T3 equals the first luminance current Igrs1. Since the transimpedance transistor T2 is configured as a diode-connected transistor, and the current flowing through the transimpedance transistor T2 is a portion of the first luminance current Igrs1, it ensures that the transimpedance transistor T2 operates in the saturation region during the steady state. The gate-source voltage of the transimpedance transistor T2 gradually increases until it reaches the operating point corresponding to the current flowing through the transimpedance transistor T2 being equal to the first luminance current Igrs1 and stops increasing. When the gate-source voltage of the transimpedance transistor T2 stops increasing, the voltage across the gate capacitance T3 also stops increasing. The electrical characteristics of the transimpedance transistor T2 are appropriately arranged so that the voltage at the transimpedance control node Ncr maintains the holding voltage Vrm. After the refresh period ends, the refresh signal RFSH turns OFF the auxiliary transistor T4 and the refresh transistor T5, preventing leakage of the gate capacitance T3 and maintaining the holding voltage Vrm.

On the other hand, during the display period, since the gate capacitance T3 is coupled between the gate and the source of the transconductance transistor T2′, the gate-source voltage of the transconductance transistor T2′ is determined by the voltage across the gate capacitance T3. Therefore, the transconductance transistor T2′ generates the second luminance current Igrs2 according to the holding voltage Vrm, and the second luminance current Igrs2 is positively correlated with the first luminance current Igrs1 (in one embodiment, they are equal since the transimpedance transistor T2 and the transconductance transistor T2′ are the same transistor). The PWM signal PWM1 serves as the display signal DIS to switch the display transistor T1, converting the second luminance current Igrs2 to the display current Idis, determining the grayscale of the light-emitting device LED1. The refresh period and the display period do not overlap; during the display period, the pixel circuit 22 supplies the display current Idis to the corresponding light-emitting device LED1.

FIG. 8B shows a schematic diagram of the pixel circuit of an electroluminescence displayer according to yet another embodiment of the present invention. The embodiment shown in FIG. 8B differs from the embodiment shown in FIG. 8A in that the pixel circuit 22 in FIG. 8B supplies plural display currents Idis1 to IdisN to the corresponding plural light-emitting devices LED1 to LEDN. Additionally, the pixel circuit 22 includes plural display transistors T1A1 to T1AN, which are respectively switched by corresponding PWM signals PWM1A to PWMNA. Furthermore, the pixel circuit 22 includes plural bypass transistors T1B1 to T1BN. The plural bypass transistors T1B1 to T1BN are respectively switched by corresponding PWM signals PWM1B to PWMNB. One end of each of the plural bypass transistors T1B1 to T1BN is coupled to the transimpedance current outflowing node Nio of the transconductance circuit 222 and the corresponding plural display transistors T1A1 to T1AN, and the other end is coupled to the bias BIAS. In this embodiment, each of the bypass transistors T1B1 to T1BN is coupled between the transimpedance current outflowing node Nio and the bias BIAS, serving as a bypass current path 226 to bypass the corresponding display currents Idis1 to IdisN when the corresponding display switch 223 is turned OFF. The PWM signals PWM1B to PWMNB are complementary signals to the corresponding PWM signals PWM1A to PWMNA.

It should be noted that the bias BIAS is used to adjust the corresponding display currents Idis1 to IdisN such that each of them is discharged through the corresponding bypass current path 226 when the corresponding display switch 223 is turned OFF. The design of the bypass current path 226 aims to provide an alternative flow path for each of the display currents Idis1 to IdisN, ensuring the stable operation of the entire circuit. When the corresponding display switch 223 is turns ON again, the display current can be quickly and smoothly transferred back to the corresponding light-emitting device, ensuring continuous operation and stable display current.

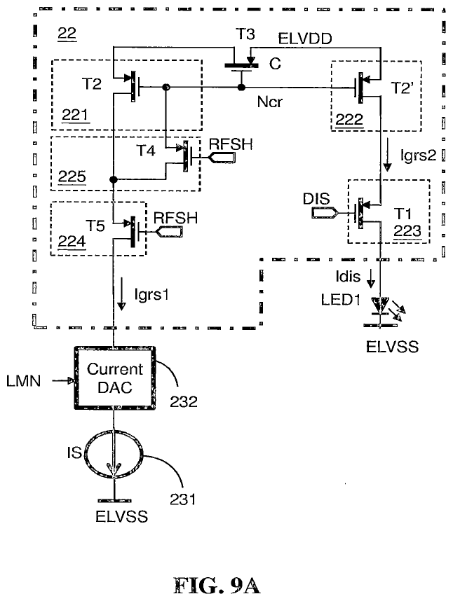

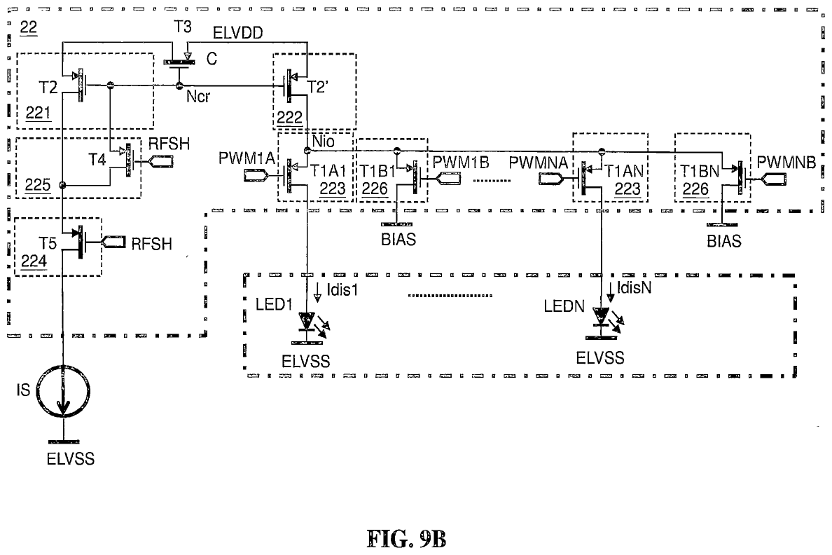

FIG. 9A shows a schematic diagram of the pixel circuit of an electroluminescence displayer according to yet another embodiment of the present invention. The pixel circuit 22 shown in FIG. 9A is a more specific embodiment of a pixel circuit 22 that can operate in an overlap mode. As shown in FIG. 9A, the pixel circuit 22 includes a transimpedance circuit 221, a transconductance circuit 222, a display switch 223, a refresh switch 224, an auxiliary switch 225, and a capacitor C. The transimpedance circuit 221 includes a transimpedance transistor T2, the transconductance circuit 222 includes a transconductance transistor T2′, the display switch 223 includes a display transistor T1, the refresh switch 224 includes a refresh transistor T5, the auxiliary switch 225 includes an auxiliary transistor T4, and the capacitor C includes the gate capacitance T3 of a MOS capacitor.

Please continue to refer to FIG. 9A. During the refresh period, the refresh signal RFSH turns ON the auxiliary transistor T4 and the refresh transistor T5, allowing the first luminance current Igrs1 to flow through the transimpedance transistor T2 and the gate capacitor T3, which are connected in parallel between the first power source ELVDD and the digital-to-analog converter 232. In other words, the sum of the current flowing through the transimpedance transistor T2 and the current flowing through the gate capacitor T3 equals the first luminance current Igrs1. Since the transimpedance transistor T2 is configured as a diode-connected transistor and the first luminance current Igrs1 partially flows through the transimpedance transistor T2, it ensures that the transimpedance transistor T2 operates in the saturation region during steady state. The gate-source voltage of the transimpedance transistor T2 will gradually increase until it reaches the operating point where the current flowing through the transimpedance transistor T2 equals the first luminance current Igrs1 and then stops increasing. When the gate-source voltage of the transimpedance transistor T2 stops increasing, the voltage across the gate capacitor T3 also stops increasing. By appropriately arranging the electrical characteristics of the transimpedance transistor T2, the voltage at the transimpedance control node Ncr is maintained at the holding voltage Vrm. After the refresh period ends, the refresh signal RFSH turns OFF the auxiliary transistor T4 and the refresh transistor T5, preventing leakage of the gate capacitor T3 and maintaining the holding voltage Vrm.

On the other hand, during the display period, since the gate capacitor T3 is coupled between the gate and the source of the transconductance transistor T2′, the gate-source voltage of the transconductance transistor T2′ is determined by the voltage across the gate capacitor T3. Therefore, the transconductance transistor T2′ generates the second luminance current Igrs2 according to the holding voltage Vrm, and the second luminance current Igrs2 is positively correlated with the first luminance current Igrs1 (in one embodiment, they are equal if the transimpedance transistor T2 and the transconductance transistor T2′ have the same electrical characteristics). The PWM signal PWM1 serves as the display signal DIS to switch the display transistor T1, converting the second luminance current Igrs2 to the display current Idis, determining the grayscale of the light-emitting device LED1. Since the transimpedance transistor T2 and the transconductance transistor T2′ are different transistors, the refresh period and the display period can overlap. During the display period, the pixel circuit 22 supplies the display current Idis to the corresponding light-emitting device LED1.

In this embodiment, the transimpedance transistor T2, the auxiliary switch 225, and the transconductance transistor T2′ of the transconductance circuit 222 form a current mirror circuit, and during the refresh period, the first luminance current is mirrored and converted into the second luminance current. The second luminance current Igrs2 generated by the transconductance circuit 222 is maintained at a fixed level relative to the first luminance current Igrs1. This embodiment can operate in an overlap mode, meaning that the refresh period and the display period are not restricted from overlapping; they can optionally have an overlap period. In one embodiment, the refresh period and the display period have an overlap period; in another embodiment, the refresh period and the display period do not overlap. Since the transconductance circuit 222 can generate and maintain the second luminance current Igrs2 relative to the first luminance current Igrs1 during both the overlap and non-overlap periods, the refresh period and the display period can overlap in the embodiment shown in FIG. 9. In one embodiment, the refresh signal RFSH is a periodic signal with a fixed period, and the period of the refresh signal RFSH depends on the matching configuration of the digital-to-analog converter 232 and the pixel circuit 22, which refers to a single-column or multi-column driving configuration by the digital-to-analog converter 232.

FIG. 9B shows a schematic diagram of the pixel circuit of an electroluminescence displayer according to yet another embodiment of the present invention. The embodiment shown in FIG. 9B differs from the embodiment shown in FIG. 9A in that the pixel circuit 22 in FIG. 9B supplies plural display currents Idis1 to IdisN to the corresponding plural light-emitting devices LED1 to LEDN. Additionally, the pixel circuit 22 includes plural display transistors T1A1 to T1AN, which are respectively switched by corresponding PWM signals PWM1A to PWMNA. Furthermore, the pixel circuit 22 includes plural bypass transistors T1B1 to T1BN. The plural bypass transistors T1B1 to T1BN are respectively switched by corresponding PWM signals PWM1B to PWMNB. One end of each of the plural bypass transistors T1B1 to T1BN is coupled to the transimpedance current outflowing node Nio of the transconductance circuit 222 and the corresponding plural display transistors T1A1 to T1AN, and the other end is coupled to the bias BIAS. In this embodiment, each of the bypass transistors T1B1 to T1BN is coupled between the transimpedance current outflowing node Nio and the bias BIAS, serving as a bypass current path 226 to bypass the corresponding display currents Idis1 to IdisN when the corresponding display switch 223 is turned OFF. The PWM signals PWM1B to PWMNB are complementary signals to the corresponding PWM signals PWM1A to PWMNA.

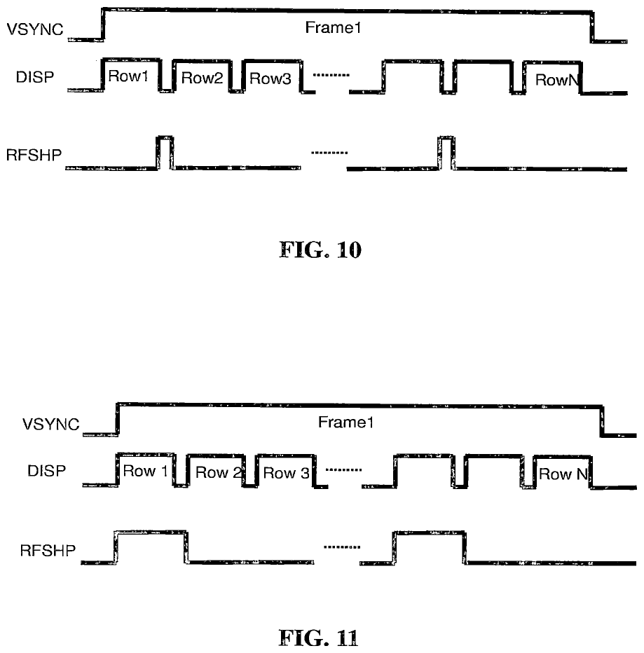

FIG. 10 shows a schematic diagram of the signal waveform of an electroluminescence displayer operating in non-overlap mode according to an embodiment of the present invention. As shown in FIG. 10, in non-overlap mode, the frame enable signal VSYNC indicates a frame period Frame1, where the display enable signal DISP is at a high level, indicating the row enable periods Row1, Row2, Row3, RowN, i.e., the display period. When the display enable signal DISP is at a low level, it indicates the gap period between the row enable periods Row1, Row2, Row3, RowN, which can be arranged as the refresh period, as indicated by the refresh enable signal RFSHP.

FIG. 11 shows a schematic diagram of the signal waveform of an electroluminescence displayer operating in overlap mode according to another embodiment of the present invention. As shown in FIG. 11, in overlap mode, the frame enable signal VSYNC indicates a frame period Frame1, where the display enable signal DISP is at a high level, indicating the row enable periods Row1, Row2, Row3, RowN, i.e., the display period. When the display enable signal DISP is at a low level, it indicates the gap period between the row enable periods Row1, Row2, Row3, RowN. Unlike the non-overlap mode shown in FIG. 10, in overlap mode, the refresh period, as indicated by the refresh enable signal RFSHP, can overlap with the display period (as indicated by the high level of the display enable signal DISP).

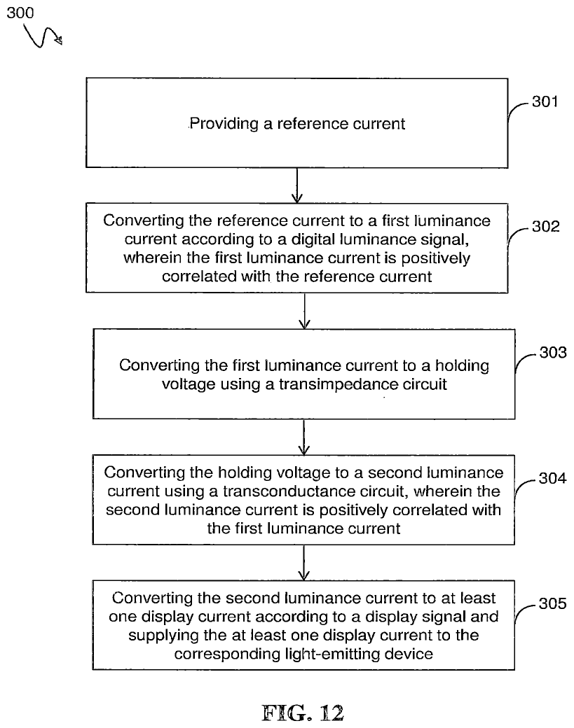

FIG. 12 shows a flowchart of the control method for an electroluminescence displayer according to an embodiment of the present invention. As shown in FIG. 12, the control method 300 for an electroluminescence displayer includes:
Step 301: Providing a reference current;
Step 302: Converting the reference current to a first luminance current according to a digital luminance signal, wherein the first luminance current is positively correlated with the reference current;
Step 303: Converting the first luminance current to a holding voltage using a transimpedance circuit;
Step 304: Converting the holding voltage to a second luminance current using a transconductance circuit, wherein the second luminance current is positively correlated with the first luminance current; and
Step 305: Converting the second luminance current to at least one display current according to a display signal and supplying the at least one display current to the corresponding light-emitting device;
wherein the first luminance current is converted to the display current that flows through the corresponding light-emitting device in a current control manner.

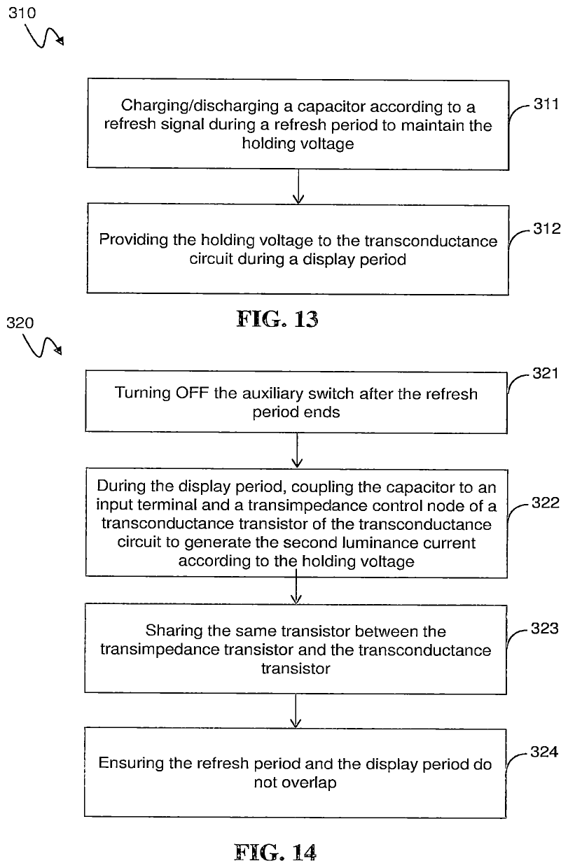

FIG. 13 shows a flowchart of the refresh and display steps in the control method for an electroluminescence displayer according to an embodiment of the present invention. As shown in FIG. 13, the pre-steps 310 of the refresh step and the display step include:
Step 311: Charging/discharging a capacitor according to a refresh signal during a refresh period to maintain the holding voltage; and
Step 312: Providing the holding voltage to the transconductance circuit during a display period.

FIG. 14 shows a flowchart of the control method for an electroluminescence displayer operating in non-overlap mode according to an embodiment of the present invention. As shown in FIG. 14, the control method for an electroluminescence displayer further includes operating in non-overlap mode step 320, including:
Step 321: Turning OFF the auxiliary switch after the refresh period ends;
Step 322: During the display period, coupling the capacitor to an input terminal and a transimpedance control node of a transconductance transistor of the transconductance circuit to generate the second luminance current according to the holding voltage;
Step 323: Sharing the same transistor between the transimpedance transistor and the transconductance transistor; and
Step 324: Ensuring the refresh period and the display period do not overlap;
wherein during the display period, the pixel circuit supplies the display current to the corresponding light-emitting device.

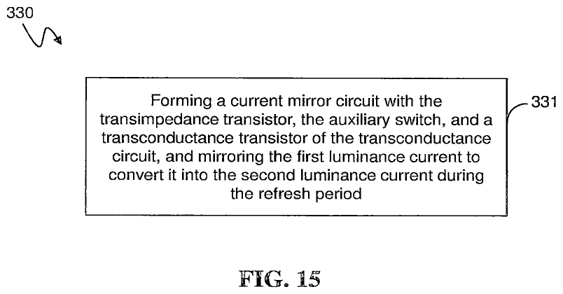

FIG. 15 shows a flowchart of the control method for an electroluminescence displayer operating in overlap mode according to an embodiment of the present invention, wherein the refresh step further includes forming a current mirror circuit. As shown in FIG. 15, the refresh step in overlap mode further includes step 330, including:
Step 331: Forming a current mirror circuit with the transimpedance transistor, the auxiliary switch, and a transconductance transistor of the transconductance circuit, and mirroring the first luminance current to convert it into the second luminance current during the refresh period.

The present invention has been described in considerable detail with reference to certain preferred embodiments thereof. It should be understood that the description is for illustrative purpose, not for limiting the scope of the present invention. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. Furthermore, those skilled in this art can readily conceive variations and modifications within the spirit of the present invention. As another example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. The spirit of the present invention should cover all such and other modifications and variations, which should be interpreted to fall within the scope of the following claims and their equivalents.

What is claimed is:

1. An electroluminescence displayer, comprising:
a light emitting device array, which includes a plurality of light emitting devices arranged in a plurality of rows and a plurality of columns;
a plurality of pixel circuits, wherein each pixel circuit is respectively coupled to at least one corresponding light emitting device, to supply at least one corresponding display current to the at least one corresponding light emitting device according to at least one display signal; and
a driver circuit, coupled to the plural pixel circuits, to provide a first luminance current to the corresponding pixel circuit according to a digital luminance signal;
wherein the electroluminescence displayer controls the corresponding pixel circuit in a current control manner, to convert the first luminance current to the display current that flows through the at least one corresponding light emitting device.

2. The electroluminescence displayer of claim 1, wherein the driver circuit includes:
a reference current source, which is configured to operably provide a reference current; and
a plurality of current digital-to-analog converters (DACs), wherein each current DAC is configured to operably convert the reference current to a first luminance current according to the digital luminance signal, wherein the first luminance current is positively correlated with the reference current.

3. The electroluminescence displayer of claim 2, wherein the pixel circuit includes:
a transimpedance circuit, which is configured to operably convert the first luminance current to a holding voltage;
a transconductance circuit, which is configured to operably convert the holding voltage to a second luminance current, wherein the second luminance current is positively correlated with the first luminance current; and
at least one display switch, which is configured to operably convert the second luminance current to the corresponding display current according to the display signal, to supply the corresponding display current to the corresponding light emitting device.

4. The electroluminescence displayer of claim 3, wherein the display signal includes a pulse width modulation (PWM) signal with a duty ratio, and the PWM signal is used to switch the corresponding display switch, thereby generating the display current to determine a grayscale of the corresponding light emitting device.

5. The electroluminescence displayer of claim 3, wherein the pixel circuit further includes at least one bypass current path, wherein each bypass current path and the corresponding display switch are commonly coupled to a current outflow node of the transconductance circuit to bypass the corresponding display current when the corresponding display switch is turned OFF.

6. The electroluminescence displayer of claim 3, wherein the pixel circuit further includes a capacitor, which is coupled to the transimpedance circuit during a refresh period to maintain the holding voltage and coupled to the transconductance circuit during a display period to provide the holding voltage to the transconductance circuit.

7. The electroluminescence displayer of claim 6, wherein the capacitor includes a gate capacitor of a MOS capacitor.

8. The electroluminescence displayer of claim 6, wherein the pixel circuit further includes a refresh switch to couple the driver circuit to the capacitor during the refresh period according to a refresh signal to charge/discharge the capacitor to maintain the holding voltage.

9. The electroluminescence displayer of claim 8, wherein the pixel circuit further includes an auxiliary switch to electrically couple a transimpedance current outflowing node to a transimpedance control node of the transimpedance transistor of the transimpedance circuit during the refresh period, configured as a diode-connected transistor to couple the capacitor in parallel between a first power source and the current DAC to charge/discharge the capacitor to maintain the holding voltage.

10. The electroluminescence displayer of claim 9, wherein the auxiliary switch is turned OFF after the refresh period, and the capacitor is coupled to a transconductance inflow node and a transconductance control node of a transconductance transistor of the transconductance circuit during the display period to generate the second luminance current according to the holding voltage, wherein the transimpedance transistor and the transconductance transistor share the same transistor, and the refresh period and the display period do not overlap; wherein the pixel circuit supplies the display current to the at least one corresponding light emitting device during the display period.

11. The electroluminescence displayer of claim 9, wherein the transimpedance transistor, the auxiliary switch, and a transconductance transistor of the transconductance circuit form a current mirror circuit to mirror the first luminance current to the second luminance current during the refresh period.

12. The electroluminescence displayer of claim 11, wherein the refresh period and the display period optionally have an overlap period or do not overlap.

13. The electroluminescence displayer of claim 7, wherein during the refresh period, the electroluminescence displayer synchronously charges the plural gate capacitors corresponding to the plural light emitting devices in at least one row.

14. A driver circuit of an electroluminescence displayer, wherein the electroluminescence displayer includes a light emitting device array, which includes a plurality of light emitting devices arranged in a plurality of rows and a plurality of columns; a plurality of pixel circuits, wherein each pixel circuit is respectively coupled to at least one corresponding light emitting device, to supply at least one corresponding display current to the at least one corresponding light emitting device according to at least one display signal; and the driver circuit coupled to the plural pixel circuits to provide a first luminance current to the corresponding pixel circuit according to a digital luminance signal; wherein the electroluminescence displayer controls the corresponding pixel circuit in a current control manner to convert the first luminance current to the display current that flows through the at least one corresponding light emitting device; the driver circuit of the electroluminescence displayer, comprising:
a reference current source, which is configured to operably provide a reference current; and
a plurality of current DACs, wherein each current DAC is configured to operably convert the reference current to a first luminance current according to the digital luminance signal, wherein the first luminance current is positively correlated with the reference current.

15. A pixel circuit of an electroluminescence displayer, wherein the electroluminescence displayer includes a light emitting device array, which includes a plurality of light emitting devices arranged in a plurality of rows and a plurality of columns; a plurality of pixel circuits, wherein each pixel circuit is respectively coupled to at least one corresponding light emitting device, to supply at least one corresponding display current to each corresponding light emitting device according to at least one display signal; and a driver circuit coupled to the plural pixel circuits to provide a first luminance current to the corresponding pixel circuit according to a digital luminance signal; wherein the electroluminescence displayer controls the corresponding pixel circuit in a current control manner to convert the first luminance current to the display current that flows through the at least one corresponding light emitting device; the pixel circuit of the electroluminescence displayer, comprising:
a transimpedance circuit, which is configured to operably convert the first luminance current to a holding voltage;
a transconductance circuit, which is configured to operably convert the holding voltage to a second luminance current, wherein the second luminance current is positively correlated with the first luminance current; and
at least one display switch, which is configured to operably convert the second luminance current to the corresponding display current according to the display signal, to supply the corresponding display current to the corresponding light emitting device.

16. The pixel circuit of the electroluminescence displayer of claim 15, wherein the driver circuit includes:
a reference current source, which is configured to operably provide a reference current; and
a plurality of current DACs, wherein each current DAC is configured to operably convert the reference current to a first luminance current according to the digital luminance signal, wherein the first luminance current is positively correlated with the reference current.

17. The pixel circuit of the electroluminescence displayer of claim 15, wherein the display signal includes a PWM signal with a duty ratio, and the PWM signal is used to switch the corresponding display switch, thereby generating the display current to determine a grayscale of the corresponding light emitting device.

18. The pixel circuit of the electroluminescence displayer of claim 15, further comprising at least one bypass current path, wherein each bypass current path and the corresponding display switch are commonly coupled to a current outflow node of the transconductance circuit to bypass the corresponding display current when the corresponding display switch is turned OFF.

19. The pixel circuit of the electroluminescence displayer of claim 15, further comprising a capacitor, which is coupled to the transimpedance circuit during a refresh period to maintain the holding voltage and coupled to the transconductance circuit during a display period to provide the holding voltage to the transconductance circuit.

20. The pixel circuit of the electroluminescence displayer of claim 19, wherein the capacitor includes a gate capacitor of a MOS capacitor.

21. The pixel circuit of the electroluminescence displayer of claim 19, further comprising a refresh switch to couple the driver circuit to the capacitor during the refresh period according to a refresh signal to charge/discharge the capacitor to maintain the holding voltage.

22. The pixel circuit of the electroluminescence displayer of claim 21, further comprising an auxiliary switch to electrically couple a transimpedance current outflowing node to a transimpedance control node of the transimpedance transistor of the transimpedance circuit during the refresh period, configured as a diode-connected transistor to couple the capacitor in parallel between a first power source and the current DAC to charge/discharge the capacitor to maintain the holding voltage.

23. The pixel circuit of the electroluminescence displayer of claim 21, wherein the auxiliary switch is turned OFF after the refresh period, and the capacitor is coupled to a transconductance inflow node and a transconductance control node of a transconductance transistor of the transconductance circuit during the display period to generate the second luminance current according to the holding voltage, wherein the transimpedance transistor and the transconductance transistor share the same transistor, and the refresh period and the display period do not overlap; wherein during the display period, the pixel circuit supplies the display current to the at least one corresponding light emitting device.

24. The pixel circuit of the electroluminescence displayer of claim 21, wherein the transimpedance transistor, the auxiliary switch, and a transconductance transistor of the transconductance circuit form a current mirror circuit to mirror the first luminance current to the second luminance current during the refresh period.

25. The pixel circuit of the electroluminescence displayer of claim 24, wherein the refresh period and the display period optionally have an overlap period or do not overlap.

26. The pixel circuit of the electroluminescence displayer of claim 20, wherein during the refresh period, the electroluminescence displayer synchronously charges the gate capacitors corresponding to the plural light emitting devices in at least one row.

27. A control method for an electroluminescence displayer, comprising:
providing a reference current;
converting the reference current to provide a first luminance current according to a digital luminance signal, wherein the first luminance current is positively correlated with the reference current;
converting the first luminance current to a holding voltage with a transimpedance circuit;
converting the holding voltage to a second luminance current with a transconductance circuit, wherein the second luminance current is positively correlated with the first luminance current; and
converting the second luminance current to at least one display current according to a display signal to supply the at least one display current to at least one corresponding light emitting device;
wherein the first luminance current is converted to the display current that flows through the at least one corresponding light emitting device in a current control manner.

28. The control method of the electroluminescence displayer of claim 27, wherein the display signal includes a PWM signal with a duty ratio, and the PWM signal is used to switch a corresponding display switch, thereby generating the display current to determine a grayscale of the corresponding light emitting device.

29. The control method of the electroluminescence displayer of claim 27, further comprising:
a refresh step, including charging/discharging a capacitor during a refresh period according to a refresh signal to maintain the holding voltage; and
providing the holding voltage to the transconductance circuit during a display period.

30. The control method of the electroluminescence displayer of claim 29, wherein the capacitor includes a gate capacitor of a MOS capacitor.

31. The control method of the electroluminescence displayer of claim 29, wherein the refresh step includes providing an auxiliary switch to electrically couple a transimpedance current outflowing node to a transimpedance control node of the transimpedance transistor of the transimpedance circuit during the refresh period, configured as a diode-connected transistor to couple the capacitor in parallel between a first power source and the current DAC to charge/discharge the capacitor to maintain the holding voltage.

32. The control method of the electroluminescence displayer of claim 31, wherein the electroluminescence displayer operates in a non-overlap mode, the control method further comprising:
turning OFF the auxiliary switch after the refresh period;
coupling the capacitor to a transconductance inflow node and a transconductance control node of a transconductance transistor of the transconductance circuit during the display period to generate the second luminance current according to the holding voltage;
sharing the same transistor between the transimpedance transistor and the transconductance transistor; and
ensuring the refresh period and the display period do not overlap;
wherein the pixel circuit supplies the display current to the corresponding light emitting device during the display period.

33. The control method of the electroluminescence displayer of claim 31, wherein the electroluminescence displayer operates in an overlap mode, the refresh step further comprising forming a current mirror circuit with the transimpedance transistor, the auxiliary switch, and the transconductance transistor of the transconductance circuit to mirror the first luminance current to the second luminance current during the refresh period.

34. The control method of the electroluminescence displayer of claim 33, wherein the refresh period and the display period optionally have an overlap period or do not overlap.

35. The control method of the electroluminescence displayer of claim 30, wherein the refresh step of charging/discharging the capacitor during the refresh period to maintain the holding voltage further includes synchronously charging the plural gate capacitors corresponding to the plural light emitting devices in at least one row during the refresh period.
